(19) United States
(12) Patent Application Publication
(10) Pub. No.: US 2005/0030630 A1
(43) Pub. Date: Feb. 10, 2005

(54) Reflective film

(76) Inventors: Arataka Ohnishi, Nagasaki (JP); Satoshi Ogawa, Nagasaki (JP)

Correspondence Address: FINNEGAN, HENDERSON, FARABOW, GARRETT & DUNNER;LLP, 1300 I STREET, NW, WASHINGTON, DC, 20005, US

(21) Appl. No.: 10/490,871

(22) PCT Filed: Sep. 27, 2001
(86) PCT No.: PCT/JP01/08427

(51) Int. Cl. G02B 5/02

(52) U.S. Cl. 359/599; 362/31

(57) ABSTRACT

Provided is a reflection film for a backlight optical system as a constituent of a display having a high quality by preventing damage on a light guiding plate, especially a polyolefin-based light guiding plate, with intrinsic performances of the reflection film such as an optical characteristic, a blocking property, tractability and the like sustained. A reflection film used in a backlight optical system consisting of a light source, a light guiding plate and a reflection film, wherein a resin layer containing particles with elasticity is provided on a surface, in contact with the light guiding plate, of the reflection film. The reflection film contains particles with elasticity therein. It is preferable that the particles with elasticity each have a cushioning property and elasticity and a rubber hardness (JIS K6253) of 50 or less. Specifically, the particles with elasticity each are preferably made of silicone, crosslinked polyacrylate ester, polyurethane or the like. The diameters of the particles with elasticity are preferably in the range of from 1 to 60 μm.

### TECHNICAL FIELD

The invention relates to a reflection film. More particularly, the invention relates to a reflection film with high homogeneity used in a backlight optical system for a liquid crystal display.

### BACKGROUND ART

A liquid crystal display is rapidly enlarging its application fields as a display means for IT-related equipments such as a computer, a television set, a mobile, communication equipment and the like. Especially, reduction in weight, downsizing, an improved display quality and such have been strongly requested in a notebook personal computer, a portable telephone, a mobile and the like from the viewpoint of portability and convenience. Along with such a trend, reduction in weight, downsizing and, in addition, toughness have also been increasingly desired in a backlight unit, which is a component of such IT-equipment.

A sidelight type backlight unit is basically, as shown in FIG. 3, an optical system consisting of a light source 5, a light guiding plate 4 and a reflection film 1. The light guiding plate has been conventionally made of an acrylic resin plate from the viewpoint of an optical performance and formability, whereas a light guiding plate made of a polyolefin-based resin has been employed so as to make it to be adapted for various requests such as downsizing, reduction in weight, toughness, heat resistance, moisture resistance, low warping, low bending, improved display quality and the like. The reflection film provided on the back surface of the light guiding plate has been made of a polyester-based resin or a polyolefin-based resin.

A polyolefin-based resin light guiding plate is preferably made of, for example, Zeonor resin manufactured by Nippon Zeon Co., Ltd. A polyolefin-based resin light guiding plate has a specific gravity considerably smaller than that of an acrylic plate, and thus, it is effective for downsizing and reduction in weight.

A polyolefin-based resin light guiding plate, however, has had a problem of receiving pressure damage easily because of the presence of an inorganic additive included in a depressed or protruded portion on the surface of the reflection film when constructing a backlight optical system by combining the light guiding plate and the reflection film. When the light guiding plate receives pressure damages, bright spots and dark spots are produced on the plate at the location of pressure damage, thus, resulting in loss of a quality of a display.

It is an object of the present invention to provide a reflection film for a backlight optical system as a component of a display having a high quality free of damage on a light guiding plate caused by a property of a surface of the reflection film or a physical quality of the film with intrinsic performances of the reflection film such as an optical characteristic, a blocking property, tractability and the like sustained, especially, in a case where a polyolefin-based light guiding plate is employed.

### DISCLOSURE OF THE INVENTION

The invention is directed to a reflection film wherein a resin layer containing particles with elasticity is provided on a surface, in contact with a light guiding plate, of the reflection film. Alternatively, the invention is directed to a reflection film containing particles with elasticity therein. In another words, the reflection film according to the invention is a reflection film used in a backlight optical system consisiting of a light source, a light guiding plate and a reflection film, and has a structure in which a resin layer containing particles with elasticity is provided on the surface, in contact with a light guiding plate, of the reflection film. Alternatively, it is a reflection film used in a backlight optical system consisiting of a light source, a light guiding plate and a reflection film and is a reflection film containing particles with elasticity therein.

The light guiding plate is preferably made of a polyolefin-based resin. While what is generally used as a light guiding plate is an acrylic resin plate or a polyolefin-based resin plate, it is preferable to employ a polyolefin-based resin plate in the invention from the viewpoint of downsizing and reduction in weight. It is preferable that the particles with elasticity (hereinafter also referred to as elastic particles) each has a cushioning property and elasticity and a rubber hardness (JIS K6253) of 50 or less. Specifically, the particles with elasticity are each preferably made of at least one kind selected from the group consisting of silicone, crosslinked polyacrylate ester and polyurethane. Particles made of the respective resins included in the group may be employed either in a single kind or in a mixture of two or more kinds.

The elastic particles each are preferably spherical. This is because spherical particles are preferably spread over a reflection film easily. Diameters of the elastic particles are preferably in the range of from 1 to 60 μm and more preferably in the range of from 1 to 40 μm. The average diameter of the elastic particles (hereinafter it means in diameter) is preferably in the range of from 5 to 20 μm.

The reflection film is generally made of a polyester-based resin or a polyolefin-based resin. In the invention, a film can be employed that is produced by stretching a film made of a polyester-based resin or a polyolefin-based resin containing an inorganic filler such as calcium carbonate, titanium oxide or the like to form a number of microvoids therein and to thereby cause the stretched film to have a light reflection function. Furthermore, a transparent film can be employed that is made of a polyester-based resin or a polyolefin-based resin, or alternatively, a white film can be employed that is produced by adding titanium oxide or the like into the transparent film. Moreover, there can be employed a reflection film with a vapor deposited layer made of silver or aluminum thereon.

One of the features of the invention resides in providing a resin layer containing elastic particles on the surface, in contact with a light guiding plate, of a reflection film. Another feature of the invention resides in a reflection film containing elastic particles being therein. With a resin layer containing elastic particles provided, the elastic particles serves as a cushioning material between a light guiding plate and the reflection film when the plate and the film become in contact with each other, thereby preventing the light guiding plate from being damaged. With a reflection film containing elastic particles therein, a similar effect is obtained. Especially, in a case where a light guiding plate is made of a polyolefin-based resin, the effect is enhanced considerably.

The reflection film is made of a polyester-based resin or a polyolefin-based resin. This is because these resins are high in light transparency and are excellent in durability. As for the binder which fixes particles to the film and which s at least one or more kinds selected from the group consisting of a polyester resin, an acrylic resin, a silicone acrylic resin, a fluororesin and a fluorine-containing acrylic resin; the resins to which a crosslinkable resin having a hardening function is added; and curable resins such as a polyurethane-based resin, an epoxy-based resin and the like.

The reflection film of the invention can be produced by a procedure in which the elastic particles are mixed with a binder in a solvent, and the mixture is coated on the film and after the coating, a heat treatment is applied to the film to remove the solvent to thereby fix the elastic particles onto the film.

### BRIEF DESCRIPTION OF THE DRAWINGS

FIG. 1 is a view showing the construction of a backlight optical system using a reflection film of the invention.

FIG. 2 is a view showing the construction of a reflection film of the invention.

FIG. 3 is a view illustrating a general backlight optical system.

### BEST MODE FOR CARRYING OUT THE INVENTION

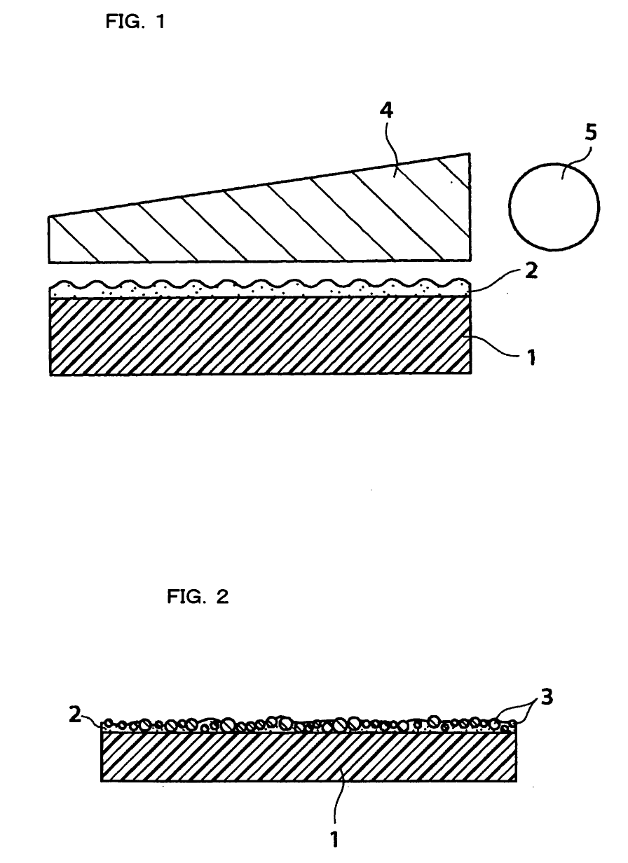

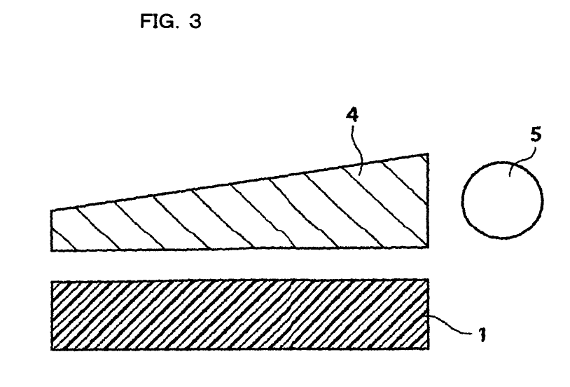

Description of the invention will be given based on embodiments. A basic construction of the invention is shown in FIG. 1 and an enlarged view of the reflection film is shown in FIG. 2. A backlight optical system of the invention basically includes a light source 5; a light guiding plate 4; and a reflection film 1 having a resin layer 2 containing elastic particles 3 therein. The resin layer 2 containing the elastic particles 3 is provided on a surface, in contact with the light guiding plate 4, of the reflection film 1. The elastic particles 3 resides between the light guiding plate 4 and the reflection film 1 to thereby absorb a pressure therebetween to prevent the light guiding plate 4 from receiving a damage. Though not shown in the figure, the reflection film containing elastic particles therein also shows the effect of preventing the light guiding plate from being damaged.

A reflection film 1 is a film or a white film made of a polyester-based resin or a polyolefin-based resin. The white film is fabricated in a procedure in which a plastic resin is added with, for example, a pigment such as titanium oxide, barium sulfate, calcium carbonate, aluminum hydroxide, magnesium carbonate, aluminum oxide or the like is added to a plastic resin so as to make it white before the plastic resin is formed into a film or a sheet, and then formed into a film or a sheet. Alternatively, a reflection film can also be used that is fabricated in a procedure in which an inorganic filler such as calcium carbonate, titanium oxide or the like is mixed into a resin, followed by stretching to form a number of microvoids therein. In order to enhance a reflection efficiency, a reflection film can also be used that has a vapor deposited layer made of silver or aluminum thereon. The reflection film may be coated with a resin layer, thereon, that contains a pigment such as titanium oxide, barium sulfate, calcium carbonate, aluminum hydroxide, magnesium carbonate, aluminum oxide or the like so as to make it white.

While an acrylic resin plate or a polyolefin resin plate is used as the light guiding plate 4, a polyolefin-based resin plate is preferably employed from the viewpoint of downsizing and reduction in weight of the backlight optical system.

The elastic particles used in the invention are particles with a cushioning property and an elastic property. The elastic particles preferably have, as the standard of elasticity, a rubber hardness (JIS K6253) of 50 or less, and more preferably have a rubber hardness (JIS K6253) of 30 or less. As the specific examples of the elastic particles, there can be presented particles made of silicone, crosslinked polyacrylate ester, polyurethane or the like. Employed is at least one kind of the elastic particles presented above. The elastic particles may be employed alone or in a mixture of two or more kinds.

Silicone elastic particles that can be preferably employed are encapsulated with a resin from the viewpoint of compatibility with, an adhesion property to and dispersibility in the binder resin.

No specific limitation is imposed on the shapes of the elastic particles, but the shape of each elastic particle is preferably spherical from the viewpoint of uniformity in depressions and protrusions of the resin layer containing particles to be formed, dispersibility in a binder resin and the like. The sizes of the particles are preferably in the range of 1 to 60 μm in diameter. The sizes of the particles are more preferably 40 μm or less in diameter. The average particle diameter is preferably in the range of from 5 to 20 μm. If the particle diameters are less than 1 μm, a blocking property and a cushioning property are hard to be obtained between the light guiding plate 4 and the reflection film 1, while if the particle diameters exceed 60 μm, a thickness of a resin layer is necessary to be large from the viewpoint of an adhesion property between the binder resin and the particles and retainability of the particles in the resin layer (the particle is hard to fall off). With a thick resin layer being adopted, a glossiness of the resin layer increases with the decrease in reflectance of the reflection film.

A binder resin is used in order to fix the elastic particles 3 to the reflection film 1, which is a substrate material. Employed as the binder resin is a resin good in resistance to light and transparency, such as polyester resin, acrylic resin, silicone acrylic resin, fluororesin or the like. Resins that can be added to a binder resin are a crosslinkable resin, such as an ultraviolet curable resin, an electron beam curable resin, a thermo-curable resin, an isocyanate-curable resin, an epoxy-curable resin and the like. The thickness of a supporter is preferably in the rage of from 30 to 300 μm and more preferably in the order of 50 to 200 μm from the viewpoint of tractability, reflection characteristic and reduction in weight.

A resin described above and elastic particles are mixed in a solvent. Then, after the solution containing the elastic particles and the binder resin are adjusted to show a proper viscosity, and the solution is coated on a reflection film 1. After the coating, the coat on the reflection film 1 is dried and heat treated to fix the elastic particles to the predetermined plastic film. In addition, a screen printing method, a coating method or the like can be applied on the surface of the reflection film to form a resin layer containing elastic particles thereon.

A reflection film containing elastic particles can be fabricated by mixing the elastic particles into a resin to extrude the mixture, for example, through a T-die, to form a film-like sheet and to then stretch the sheet when required.

The amount of elastic particles to be mixed may be 0.5 part by weight relative to 100 parts by weight of a binder resin only for preventing a damage on a light guiding plate 4. The mixing ratio of elastic particles is, however, preferably in the range of 0.8 part by weight to 200 parts by weight relative to 100 parts by weight of a binder resin from the viewpoint of the light reflection characteristic, the blocking property, tractability and the like of the reflection film 1. If the mixing ratio exceeds 200 parts by weight, the elastic particles tend to fall off easily.

The reflection film thus fabricated is cut to obtain a piece having a size that matches the size of the light guiding plate, or alternatively, the reflection film thus fabricated is imparted with a print pattern thereon for light adjustment, and thereafter, cut to obtain a piece, which is disposed on a back surface of the light guiding plate so as to be in contact therewith. A reflection film is, in a case, used together with a lamp reflector to form a single body by means of a bending method, a score cutting method or a half cutting method.

A resin layer containing elastic particles preferably have also a blocking function between the light guiding plate and the reflection film in addition to the purpose of preventing the damage to the light guiding plate. For that purpose, it is not preferable to have an excessively thick resin layer since it is undesirable to have all of the elastic particles buried in the resin layer. Since the elastic particles fall off when a thin resin layer is adopted, a certain level of the resin layer's thickness is required. The thickness of the resin layer is preferably in the order of one/fifth to four/fifths of the average particle diameter of elastic particles.

### EXAMPLES 1 TO 6

Prepared was a white polyester film (produced by TORAY INDUSTRIES, INC, with a trade name of E60L) with a thickness of 188 μm containing calcium carbonate. Then, various kinds of elastic particles (a rubber hardness of 30) shown in Table 1 were mixed in a solvent consisting of toluene, methyl ethyl ketone and butyl acetate to form a solutions. Viscosities and the like of the solution were adjusted, and the solution was applied on the reflection surface of the polyester reflection film, and the coat thereon was dried and heat treated and subjected to aging to thereby form a resin layer containing elastic particles and obtain a reflection film. Thus obtained film was cut into a piece having a proper size and was combined with the polyolefin-based light guiding plate to form a backlight optical system.

A load of 10 kg was applied on the back surface of each of the backlight optical system over an area of the order of 5 mm in diameter. After the backlight optical system was left for 24 hours under the load, visual inspection was conducted on the backlight optical system to determine the level of damage and light spots of the light guiding plate. Results of the inspection are shown in Table 1. Note that a column of added amounts in Table 1 shows part or parts by weight of elastic particles added with respect to 100 parts by weight of a binder resin and symbols in columns of damage and light spots on the light guiding plates are evaluated at three ratings, in which a mark □ is a level at which neither damage nor a light spot is recognized on a display when a light source is turned on, a mark ∘ is a level at which a recess on the slightest scale can be recognized without a practical problem being posed and a symbol x is a level at which damage or light spots can be recognized with a practical problem being posed.

TABLE 1

| | | | | | damage on | |
|---|---|---|---|---|---|---|
| | | average diameter | added amounts | film thickness | light | light |
| Example | elastic particles | (μm) | (parts by weight) | (μm) | guiding plate | spots |
| 1 | silicone | 10 | 0.8 | 5 | ◯ | □ |
| | particles | (spherical) | 10 | 10 | ◯ | □ |
| | | | 200 | 5 | ◯ | □ |
| | | | | 10 | ◯ | □ |
| | | | | 5 | ◯ | □ |
| | | | | 10 | ◯ | □ |
| 2 | silicone | 30 | 0.8 | 12 | ◯ | □ |
| | particles | (spherical) | 10 | 25 | ◯ | □ |
| | | | 200 | 12 | ◯ | □ |
| | | | | 25 | ◯ | □ |
| | | | | 12 | ◯ | □ |
| | | | | 25 | ◯ | □ |
| 3 | Crosslinked | 10 | 0.8 | 6 | ◯ | □ |
| | polyacrylate | (perfectly spherical) | 10 | 10 | ◯ | □ |
| | ester particles | | 200 | 6 | ◯ | □ |
| | | | | 10 | ◯ | □ |
| | | | | 6 | ◯ | □ |
| | | | | 10 | ◯ | □ |
| 4 | Crosslinked | 30 | 0.8 | 10 | ◯ | □ |
| | polyacrylate | (perfectly spherical) | 10 | 25 | ◯ | □ |
| | ester particles | | 200 | 10 | ◯ | □ |
| | | | | 25 | ◯ | □ |
| | | | | 10 | ◯ | □ |
| | | | | 25 | ◯ | □ |
| 5 | Polyurethane | 9 | 0.8 | 5 | ◯ | □ |
| | particles | (perfectly spherical) | 10 | 8 | ◯ | □ |
| | | | 200 | 5 | ◯ | □ |
| | | | | 8 | ◯ | □ |
| | | | | 5 | ◯ | □ |
| | | | | 8 | ◯ | □ |
| 6 | silicone | mixture of examples 1 | 0.8 | 6 | ◯ | □ |
| | particles, | and 3 with a ratio of | 10 | 10 | ◯ | □ |
| | crosslinked | 1:1 | 200 | 6 | ◯ | □ |
| | polyacrylate | | | 10 | ◯ | □ |
| | ester | | | 6 | ◯ | □ |
| | particles | | | 10 | ◯ | □ |

### EXAMPLE 7

Mixed together were 100 parts by weight of acrylic-based photo-curable resin, 20 parts by weight of silicone particles (with a rubber hardness of 30) having 30 μm in average particle diameter, 5 parts by weight of a reactive diluent, 5 parts by weight of methyl ethyl ketone, 2 parts by weight of a photo initiator and 1 part by weight of a leveling agent, and the mixture was extruded through a die to form a film after transfer. Prepared were films of 50 μM and 100 μm in thickness. The films were irradiated with light and cured to obtain desired reflection films containing elastic particles. Inspection was conducted on levels of damage and light spots on the reflection films in a similar manner to that conducted in Examples 1 to 6. The level of damage on each of the light guiding plates was observed with a microscope to thereby enable a recess on the slightest scale to be recognized without any practical problem being posed, while the light spots were at a level of no recognition.

### COMPARATIVE EXAMPLES 1 TO 6

A resin layers containing particles on the reflection surface of the reflection film was formed in a similar manner to that employed in Examples 1 to 6. The particles were all non-elastic. In Table 2, there are shown specifications of particles and levels of damage and levels of light spots on the light guiding plates caused by the reflection film obtained. Note that a column of added amounts of Table 2 shows part or parts by weight of elastic particles added into 100 parts by weight of a binder resin and symbols in columns of damage and light spots on the light guiding plates are evaluated at three ratings, in which a mark □ is a level at which neither damage nor a light spot is recognized on a display when a light source is turned on, a mark ∘ is a level at which a recess on the slightest scale can be recognized without any practical problem being posed and a symbol x is a problematical level at which damage or light spots can be recognized.

TABLE 2

| | | | added amounts | | damage on | |
|---|---|---|---|---|---|---|
| Comparative | | average diameter | (parts by | film thickness | light guiding | light |
| Example. | elastic particles | (μm) | weight) | (μm) | plate | spots |
| 1 | acrylic resin | 8 | 0.8 | 6-7 | x | x |
| | particles | (perfectly | 10 | 6-7 | x | x |
| | | spherical) | 200 | 6-7 | x | x |
| 2 | acrylic resin | 15 | 0.8 | 12 | x | x |
| | particles | (perfectly | 10 | 12 | x | x |
| | | spherical) | 200 | 12 | x | x |
| 3 | silica particles | 3 | 0.8 | 2 | x | x |
| | | (perfectly | 10 | 2 | x | x |
| | | spherical) | 200 | 2 | x | x |
| 4 | Polyethylene | 8 | 0.8 | 7 | x | x |
| | particles | (perfectly | 10 | 7 | x | x |
| | | spherical) | 200 | 7 | x | x |
| 5 | Benzoguanamine | 15 | 0.8 | 13 | x | x |
| | formaldehyde | (spherical) | 10 | 13 | x | x |
| | condensate | | 200 | 13 | x | x |
| | particles | | | | | |
| 6 | calcium carbonate | 2-3 | 0.8 | 3 | x | x |
| | particles | | 10 | 3 | x | x |
| | | | 200 | 3 | x | x |

### COMPARATIVE EXAMPLES 7 TO 8

In Comparative Example 7, a reflection film obtained from a white polyester-based resin containing calcium carbonate as an inorganic additive was used to construct the backlight optical system, while in Comparative Example 8, a reflection film obtained from a white polyolefin-based resin containing barium sulfate as an inorganic additive similarly was used to construct the backlight optical system and inspection was conducted on levels of damage and levels of light spots on light guiding plates. In both Comparative Examples 7 and 8, damages or light spots in both cases were able to be recognized and practically problematic.

As it is clear from Comparative Examples 7 and 8, in cases where backlight optical systems were constructed with the reflection films obtained from a white polyester-based resin containing an inorganic additive and a white polyeolefin-based resin containing an inorganic additive, damages and light spots on both light guiding plates were able to be recognized and practically problematic. In cases of reflection films provided with resin layers containing ordinary particles with no elasticity as shown in Comparative Examples 1 to 6, damages or light spots on all light guiding plates were able to be visually recognized and were practically problematic. In all of Comparative Examples 1 to 8, clear dot-like damages were recognized on the light guiding plates, and the light guiding plates were used in the backlight optical systems, with the results of qualities of displays being at a low level with light spots being observed thereon.

On the other hand, in Examples 1 to 7, backlight optical systems were constructed using reflection films on which resin layers containing elastic particles, or alternatively, reflection films containing elastic particles therein, with the result that either damage or a light spot was hard to be recognized on all of the light guiding plates, and accordingly, with light spots being hard to be recognized on all of the light guiding plates, qualities of displays using the backlight optical systems were each at a level of no practical problem.

### INDUSTRIAL APPLICABILITY

By constructing a backlight optical system with a reflection film having a resin layer containing particles with elasticity on a surface, in contact with a light guiding plate, thereof, it is possible to prevent the light guiding plate, especially, the light guiding plate made of a polyolefin-based resin, from being damaged. As a result, a high quality display free of light spots can be constructed. The resin layer containing elastic particles can be provided on a reflection film in a simple process at a low cost.

Reduction in weight and downsizing have been difficult in case of an acrylic resin plate which were conventionally employed as a light guiding plate. On the other hand, the invention realizes reduction in weight and downsizing of a liquid crystal display and provides a reflection film free of light spots.

1. A reflection film used in a backlight optical system consisiting of a light source, a light guiding plate and a reflection film, wherein a resin layer containing particles with elasticity is provided on a surface, in contact with the light guiding plate, of the reflection film.

2. A reflection film used in a backlight optical system consisting of a light source, a light guiding plate and a reflection film, wherein the film contains particles with elasticity therein.

3. The reflection film according to claim 1 or 2, wherein the light guiding plate is made of a polyolefin-based resin.

4. The reflection film according to any of claims 1 to 3, wherein the particles with elasticity each have a rubber hardness of 50 or less.

5. The reflection film according to any of claims 1 to 4, wherein the particles with elasticity each are made of at least one kind selected from a group consisting of silicone, crosslinked polyacrylate ester and polyurethane.

6. The reflection film according to any of claims 1 to 5, wherein the particles with elasticity each are spherical.

7. The reflection film according to any of claims 1 to 6, wherein diameters of the particles with elasticity each are in the range of from 1 to 60 μm.

8. The reflection film according to any of claims 1 to 7, wherein diameters of the particles with elasticity each are in the range of from 1 to 40 μm.

9. The reflection film according to any of claims 1 to 8, wherein the average diameter of the particles with elasticity is in the range of from 5 to 20 μm.

10. The reflection film according to any of claims 1 to 9, wherein the film is made of a polyester-based resin or a polyolefin-based resin with microvoids therein and the film contains wherein an inorganic filler.

11. The reflection film according to any of claims 1 to 10, wherein the film is made of a white polyester-based resin film containing an inorganic filler.

12. The reflection film according to any of claims 1 to 10, wherein a vapor deposited layer made of silver or aluminum is provided on the film.
